(19) United States
(12) Patent Application Publication
(10) Pub. No.: US 2004/0260570 A1
(43) Pub. Date: Dec. 23, 2004

(54) Method and system for transfer of orders from an order management system to an electronic marketplace

(75) Inventors: Robert M.H. Dunn, Toronto (CA); Raymond K.M. Kwok, Willowdale (CA); Lev Mirlas, Thomhill (CA)

Correspondence Address: John D. Flynn, IBM Corporation, Dept. T81/Bldg. 503, PO Box 12195, Research Triangle Park, NC, 27709, US

(73) Assignee: International Business Machines Corporation, Armonk, NY

(21) Appl. No.: 10/727,016

(22) Filed: Dec. 3, 2003

(30) Foreign Application Priority Data
Jun. 17, 2003 (CA) 2432630

(51) Int. Cl. G06F 17/60

(52) U.S. Cl. 705/1

(57) ABSTRACT

An order management system permits the filling of orders for items. The items are supplied from fulfillment centres or from suppliers enrolled in electronic marketplaces. The order management system has a set of fulfillment centre objects that represent fulfillment centres. There is a release to fulfillment object for associating one or more items in an order with one of the fulfillment centres. Fulfillment instructions for items associated with a fulfillment centre object are sent to the corresponding fulfillment centre. In the order management system, electronic marketplaces are able to be represented as fulfillment centre objects to permit release to fulfillment steps to be carried out for the electronic marketplaces in a manner similar to that used when items are to be fulfilled from regular fulfillment centres.

### CROSS REFERENCE TO RELATED APPLICATIONS

This Application claims priority under 35 U.S.C. §119(a) to Canadian Patent Application No. 2432630 filed Jun. 17, 2003, which is hereby incorporated herein by reference in its entirety.

### TECHNICAL FIELD

The present invention relates generally to automated order management systems and more specifically to a system and method for transfer of orders from an order management system to an electronic marketplace.

### BACKGROUND INFORMATION

Automated order management systems have been developed using computer systems to make the process of receiving and filling orders for products more efficient. Such systems are implemented by order management software packages that permit a vendor to manage the supply of products to customers. Such systems typically model a supply arrangement having fulfillment centres. A fulfillment centre is often a warehouse or an inventory location accessible by the vendor.

An example of such a system is disclosed in Patent Cooperation Treaty application WO00175746 (Krainin, et al., Oct. 11, 2001) which describes a real-time order processing system which automatically selects fulfillment centres based on various defined criteria. Similarly, U.S. Pat. No. 6,473,739 (Showghi et al., Oct. 29, 2002) describes a ticket ordering system in which fulfillment centres are selected automatically based on seat availability and proximity to buyer.

Such systems permit the vendor to determine the products available at its fulfillment centres and to arrange for required products to be supplied to its customers in response to received orders. The typical order processing flow begins with an order being submitted. Payment from the buyer is authorized, inventory is allocated and a fulfillment centre is assigned for the order. The authorized and allocated items in the order are then released to fulfillment with the result that fulfillment instructions are issued to a fulfillment centre. Staff at the warehouse or other inventory location will follow the fulfillment instructions to package the products and send them to the specified destination address. The system permits the staff sending the shipment to the customer to confirm the shipment of the products.

Such systems work efficiently for orders that can be filled from the vendor's own inventory (i.e. for those items located at the fulfillment centres accessible to the vendor). However, to meet an order made by a customer, the vendor may wish to, or be required to, obtain items that are not in inventory (items that the vendor will obtain from other suppliers). Furthermore, even if items are available in the vendor's inventory, the vendor may wish to use another source for the items, to preserve the inventory for anticipated urgent orders. Electronic commerce marketplaces are available to permit vendors to locate and order products from one or more of the suppliers who participate in the marketplaces. A vendor that sources products from the marketplace acts, in effect, as reseller for those products and therefore in the electronic commerce marketplace the vendor has a purchaser role.

The decision to fill an order from the marketplace, instead of from inventory, is typically made by a vendor administrator. In currently available order management systems, the vendor administrator will be required to take separate steps to order the items from the marketplace. Often these steps of ordering from an electronic marketplace will be carried out by the vendor administrator using a separate automated process set up to interface with the electronic marketplace. To fill an order from this electronic marketplace will require the order information already in the order management system to be re-entered into the electronic marketplace system and will require the vendor administrator to separately track this new order in the electronic marketplace.

It is therefore desirable to provide an automated order management system that permits orders to be processed for both items available at a vendor's own fulfillment centres and for items to be obtained from an electronic marketplace. It is further desirable that such a system be built as a simple add-on to an existing order management system, thus minimizing development and deployment costs.

### SUMMARY

Accordingly, the present invention provides a system and method for improved order management where, as a result of processing customer orders, related orders are to be placed in an electronic marketplace.

According to another aspect of the invention there is provided a computer program product for filling orders for items, the items being supplied from one or more fulfillment centres or from suppliers enrolled in one or more electronic marketplaces, the computer program product including a computer usable medium having computer readable program code means embodied in the medium, and including: computer readable program code means for implementing a set of fulfillment centre objects for representing the one or more fulfillment centres and the one or more electronic marketplaces, including a first subset of the fulfillment centre objects being defined for representing corresponding fulfillment centres, and a second subset of the fulfillment centre objects being defined for representing corresponding electronic marketplaces, computer readable program code means for implementing a release to fulfillment object for associating one or more items in an order with one of the set of fulfillment centre objects, computer readable program code means for sending fulfillment instructions relating to one or more items associated with one of the first subset of fulfillment centre objects to the corresponding fulfillment centre, and computer readable program code means for sending ordering information relating to one or more items associated with one of the second subset of fulfillment centre objects to the corresponding electronic marketplace.

According to another aspect of the invention there is provided the above computer program product in which a release to fulfillment object associated with a selected one of the fulfillment centre objects in the second subset comprise data representations for tracking orders in the electronic marketplace corresponding to the selected fulfillment centre object.

According to another aspect of the invention there is provided the above computer program product in which each fulfillment centre object includes data representations for representing inventory and/or fulfillment centre priority.

According to another aspect of the invention there is provided the above computer program product in which the data representations for representing inventory and/or fulfillment centre priority in the second subset of fulfillment centre objects represents a null inventory and/or a low fulfillment centre priority.

According to another aspect of the invention there is provided the above computer program product further including computer readable program code means for pre-selecting items for association with one of the set of fulfillment centre objects based on inventory and/or fulfillment centre priority.

According to another aspect of the invention there is provided the above computer program product further including computer readable program code means for implementing an administrator interface, the administrator interface including means for confirming and over-riding the pre-selection of items for association with one of the set of fulfillment centre objects.

According to another aspect of the invention there is provided the above computer program product further including computer readable program code means for grouping items and in which the program code means for sending ordering information further includes program code means for maintaining the grouping of the items when information corresponding to the grouped items is sent to the corresponding electronic marketplace.

According to another aspect of the invention there is provided the above computer program product in which the program code means for grouping items includes program code means for grouping the items corresponding to the order from which the items are received.

According to another aspect of the invention there is provided the above computer program product in which the program code means for grouping items includes program code means for grouping the items corresponding to an aggregation of items from a single order received.

According to another aspect of the invention there is provided an order management system for filling orders for items, the items being supplied from one or more fulfillment centres or from suppliers enrolled in one or more electronic marketplaces, the system including: a set of representation means for representing the one or more fulfillment centres and the one or more electronic marketplaces, a first subset of the set of representation means for representing corresponding fulfillment centres, and a second subset of the set of representation means for representing corresponding electronic marketplaces, means for carrying out a release to fulfillment step for associating one or more items in an order with one of the set of representation means, means for sending information relating to one or more items associated with one of first subset of representation means to the corresponding fulfillment centre, and for sending information relating to one or more items associated with one of the second subset of representation means to the corresponding electronic marketplace.

According to another aspect of the invention there is provided a computer-implemented method for filling orders for items using an order management system, the items being supplied from one or more fulfillment centres or from suppliers enrolled in one or more electronic marketplaces, the order management system including a set of fulfillment centre objects for representing the one or more fulfillment centres and the one or more electronic marketplaces, including a first subset of the fulfillment centre objects being defined for representing corresponding fulfillment centres, and a second subset of the fulfillment centre objects being defined for representing corresponding electronic marketplaces, the method including the steps of associating one or more items in an order with one of the set of fulfillment centre objects using a release to fulfillment object, sending fulfillment instructions relating to one or more items associated with one of the first subset of fulfillment centre objects to the corresponding fulfillment centre, and sending ordering information relating to one or more items associated with one of the second subset of fulfillment centre objects to the corresponding electronic marketplace.

According to another aspect of the invention there is provided a computer program product including a computer-readable signal-bearing medium, the medium including means for accomplishing the above method. The medium may include a recordable data storage medium, a modulated carrier signal. The signal may be a transmission over a network and the network may be the Internet.

According to another aspect of the invention there is provided a computer program product for filling orders for items, the computer program product including a computer usable medium having computer readable program code means embodied in the medium for implementing a set of fulfillment centre objects for representing one or more fulfillment centres, for implementing a release to fulfillment object for associating one or more items in an order with one of the set of fulfillment centre objects and for sending fulfillment instructions relating to one or more items associated with one of the first subset of fulfillment centre objects to the corresponding fulfillment centre, the computer program product further including computer readable program code means embodied in the medium for representing one or more electronic marketplaces as fulfillment centre objects whereby fulfillment instructions relating to items associated with the fulfillment centre objects representing electronic marketplaces are directed to the represented electronic marketplaces.

The present invention thus improves order management systems by permitting the fulfillment of orders from the marketplace in a manner that is integrated with existing order management systems.

### BRIEF DESCRIPTION OF THE DRAWINGS

In drawings which illustrate by way of example only one embodiment of the invention,

FIG. 1 is a block diagram illustrating components in the system of one embodiment.

FIG. 2 is a flowchart showing the high level steps in the method of one embodiment.

FIG. 3 is a block diagram of a networked data processing environment where the present invention can be used.

### DETAILED DESCRIPTION

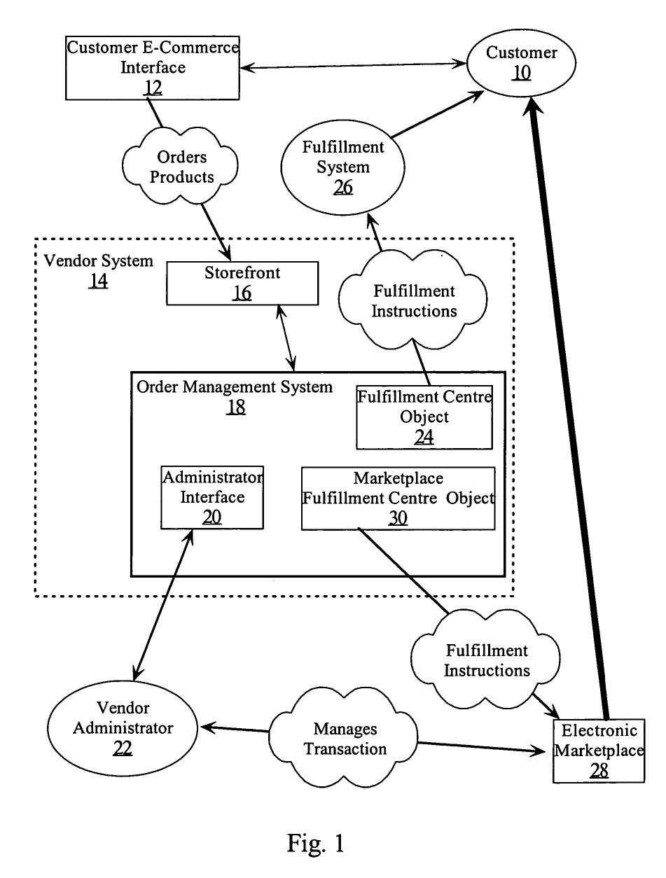

One embodiment is shown by way of example in the block diagram of FIG. 1. Customer 10 orders products using customer e-commerce interface 12. Customer e-commerce interface 12 is typically a web browser capable of accessing vendor system 14, implemented as a web-based e-commerce system, in one embodiment. In the example of FIG. 1, vendor system 14 solicits and accepts electronic orders (e-commerce orders) from customer 10 using the interface of storefront 16. Storefront 16 may be designed in any one of a number of known ways to provide functionality for customers such as customer 10 to use customer e-commerce interface 12 to electronically place orders with one or more vendors using vendor system 14. In the example of FIG. 1, storefront 16 is associated with order management system 18. As will be appreciated by those skilled in the art, a single vendor may have more than one storefront and will permit more than one customer to access each of the storefronts. Each storefront is, in one embodiment, associated with a single order management system.

It will be appreciated by those skilled in the art that order management system 18, shown with storefront 16 in FIG. 1, may be configured to permit orders to be placed through non-web channels. For example, customer 10 may place orders using telephone, fax, or email. Different order management systems may be used as order management system 18 in the present invention and the interface capabilities of such systems may vary.

Different implementations may define the configuration of storefront 16 and order management system 18 in different ways. In the simple example of FIG. 1, storefront 16 and order management system 18 are shown grouped together and located within vendor system 14. Other implementations are possible in which storefront 16 is maintained by a third party and passes information to order management system 18 that is hosted at vendor system 14. Alternatively, order management system 18 may be hosted remotely from vendor system 14. The functionality of the system as described below may be obtained from these configurations that differ from what is illustrated in the example of FIG. 1. In each case, as well as in others not described, customer 10 is able to generate orders with a vendor by using e-commerce interface 12 that passes such orders to storefront 16. Associated order management system 18 is used to process the orders. In the system shown in FIG. 1, a web-based system is used in which vendor system 14 makes web pages available using storefront 16 for display by the web browser of customer e-commerce interface 12.

Order management system 18 has administrator interface 20 accessible by vendor administrator 22. Vendor administrator 22 is a person associated with the vendor who oversees order acceptance and fulfillment for the vendor (not shown) utilizing storefront 16. Although the present invention is described in terms of “vendors” and “products” or “items”, it will be understood by those skilled in the art that the invention is also applicable to entities or persons who provide services or other intangibles to customers or clients.

Order management system 18 shown in FIG. 1 includes fulfillment centre object 24 associated with fulfillment system 26. In order management system 18, fulfillment centre object 24 represents a fulfillment centre (not shown) that corresponds to fulfillment system 26 (in other implementations, fulfillment centre object 24 may be implemented as another suitable means for the representation of a fulfillment centre in order management system 18). A fulfillment centre is a physical location where inventory for a vendor is located—typically a warehouse. In one embodiment, each fulfillment centre has an associated fulfillment system. The information and logic contained in, and associated with, each fulfillment centre object will vary depending on the implementation of the order management system.

Although the simple example of FIG. I shows only a single fulfillment centre object 24, other examples of vendor system 14 may have multiple fulfillment centre objects to represent more than one inventory storage location in the vendor's enterprise. Similarly, although FIG. 1 shows an example where fulfillment system 26 is remote from order management system 18, the two systems may be co-located such that the fulfillment system is part of the order management system.

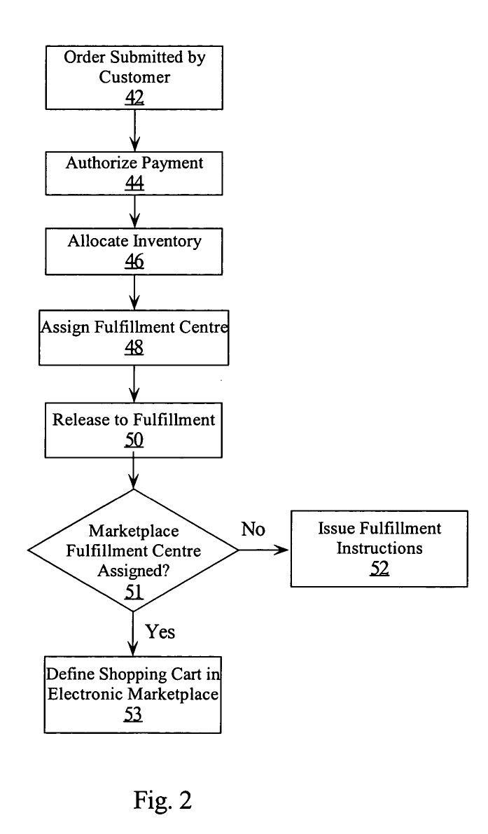

Order management system 18 has a defined protocol for processing orders and communicating with fulfillment systems. A typical order processing flow is described as follows, with reference to the flowchart of FIG. 2:

Customer 10 submits an order using customer e-commerce interface 12 and storefront 16 (see step 42 in FIG. 2). Storefront 16 passes the order, potentially containing multiple items, to order management system 18. As is typical for such systems, order management system 18 carries out the step of authorizing payment (step 44) for the order placed by customer 10.

In one embodiment, this is followed by the step of vendor administrator 22 allocating inventory for items in the order (step 46). Different items in a single order may be allocated from different sources. Vendor administrator 22 is able to determine which source to use. In one embodiment, order management system 18 may include functionality to automatically carry out a selection step to determine which fulfillment centre is best able to fill the order. In such a case, vendor administrator 22 may confirm or over-ride the selection made by order management system 18.

Order management system 18 may query fulfillment centre objects to determine the inventory available for the corresponding fulfillment centres. In one embodiment, each fulfillment centre object has associated inventory numbers and a priority rating reflecting the relative desirability of having the corresponding fulfillment centre fill an order. The inventory numbers and priority ratings stored in the fulfillment centre objects such as fulfillment centre object 24 are used when order management system 18 selects which fulfillment centre will fill the order.

As referred to above, vendor administrator 22 oversees the process of a fulfillment centre being assigned for items in the order (step 48). In one embodiment, an order item is represented by an item object having fields and, when inventory is assigned, an appropriate field in the item object will include a reference to the fulfillment centre object. This reflects the assignment of inventory for the corresponding fulfillment centre.

It is possible, and is often the implementation, that inventory numbers are not kept in fulfillment centre object 24, but instead are retrieved by order management system 18 from fulfillment system 26 via messaging in real time. In either case, the process carried out may not only query the current quantity on hand at a given fulfillment centre, but may also result in an allocation of the desired quantity of inventory from that fulfillment centre.

In some cases, inventory levels from the fulfillment centre may not be available. In such a case the present invention may assign a fulfillment centre without querying inventory levels (step 46 in FIG. 2 is effectively skipped in such a system). It should be noted that the availability of inventory information can allow the system of the embodiment to pre-assign a ‘reasonable’ fulfillment centre automatically to make this process (assign fulfillment centre, step 48 in FIG. 2) more efficient.

Once items in the order are authorized and allocated, the items may be released to fulfillment (step 50). In one embodiment, this is carried out by vendor administrator 22 initiating a process that creates a release to fulfillment object (not shown). The release to fulfillment object references order items that vendor administrator 22 determines should be taken from inventory and sent to customer 10. The release to fulfillment step results in each item object being flagged as “released” (an appropriate field in the object will have a value indicating the status “released). As part of the release to fulfillment step for an order item, the release to fulfillment object is updated to reference the corresponding item object. In this way the release to fulfillment object may reference a number of items that are to be sent to customer 10 from a given fulfillment centre.

The timing and process used to send the fulfillment instructions (step 52) from order management system 18 to fulfillment system 26 may vary between different implementations of order management system 18 and fulfillment system 26. Typically, a release to fulfillment object is created and item objects are marked as having been released without, at that time, fulfillment instructions being sent to the appropriate fulfillment system. Fulfillment instructions may later be created and sent in response to a request from fulfillment system 26. On receiving such a request, order management system 18 generates appropriate fulfillment instructions, based on any current release to fulfillment objects for the requesting fulfillment system.

Alternatively, order management system 18 sends fulfillment instructions at the time that they are created or at times defined by the logic of the order management system itself. Any of these protocols for interaction between order management system 18 and fulfillment system 26 are acceptable. In one embodiment, order management system 18 groups release to fulfillment objects for the same fulfillment system. Therefore fulfillment instructions sent to fulfillment system 26 by order management system 14 will include, in the appropriate circumstances, information about items obtained from multiple release to fulfillment objects.

Staff at the fulfillment centre corresponding to fulfillment system 26 follow the fulfillment instructions to package the items in the order and send them to the address specified in the fulfillment instructions received (as depicted by the large arrow directed from fulfillment system 26 to customer 10 in FIG. 1). A confirmation of the shipment of the items is then provided to order management system 18 by fulfillment system 26.

The above process is typically found in automated order management systems. Unlike such systems, however, the present invention can handle orders for items that cannot be filled by the vendor from its own fulfillment centres by modeling third party ordering on the existing fulfillment centre order system in the order management system. Where an order is placed by customers for certain items, the vendor may decide to fill the order from third parties, rather than from the vendor's own fulfillment centres. Fulfilling via a third party in this way is sometimes called ‘drop-shipping’. The present invention can treat third party purchasing as a variation on sending fulfillment instructions to the vendor's fulfillment centres and thus permits the order management system to make use of this drop-ship capability without the need for extensive alteration to the existing order management system.

As described above, in the example of FIG. 1, customer 10 places an order using customer e-commerce interface 12 and storefront 16. In one embodiment, orders can be received which are not able to be filled from the vendor's inventory at its fulfillment centres. In such a case, or for other reasons, vendor administrator 22 may determine that the order ought to be filled from third parties using electronic marketplace 28 (step 51).

Electronic marketplace 28 may be hosted by vendor system 14, or may be hosted by a third party. As is known in the art, electronic marketplace 28 is an automated marketplace in which suppliers may bid to fill orders placed using a trading mechanism supported by electronic marketplace 38 (for example, by use of shopping carts, requests for proposals, auctions, reverse auctions, or requests for quotations). Electronic marketplace 28 permits a shopper to select one or more suppliers from the many represented in the marketplace. In electronic marketplace 28 of one embodiment, the “vendor”, who is acting to fill the order made by a customer, is provided with an identifier for a shopping cart (created in electronic marketplace 28) for the goods that the vendor seeks to acquire from the suppliers represented in electronic marketplace 28 (step 53).

In one embodiment, functionality to permit vendor administrator 22 to make use of electronic marketplace 28 is included in order management system 18. Marketplace fulfillment centre object 30 is definable in order management system 18 to represent electronic marketplace 28. In order management system 18, this object is created and used in much the same way as fulfillment centre object 24 and may be considered to be a subset of a larger grouping of objects that includes fulfillment centre object 24 (in other implementations, marketplace fulfillment centre object 30 may be implemented as another suitable means for the representation of electronic marketplace 28 in order management system 18). In one embodiment, each electronic marketplace may be represented in order management system 18 by an appropriately defined marketplace fulfillment centre object. Thus, as described in more detail below, order management system 18 is able to handle orders to be filled from the electronic marketplace in a manner that is similar to handling orders that are to be filled from the vendor's fulfillment centres.

Vendor administrator 22 is able to use administrator interface 20 to determine when orders should be filled from electronic marketplace 28. In the embodiment, marketplace fulfillment centre object 30 represents electronic marketplace 28 as having no inventory and a low fulfillment centre priority. As a result, order management system 18 will automatically pre-select vendor's own inventory if such is available (for example, by using fulfillment system 26 and its corresponding fulfillment centre), and electronic marketplace 28 or others like it, if inventory in the fulfillment centres is not available. Vendor administrator 22 is presented with such pre-selected recommendations for inventory allocation from vendor system 14, and will use administrator interface 20 to accept, reject or modify the recommendations.

As may be seen, in one embodiment order management system 18 does not automatically carry out the release to fulfillment step. Vendor administrator 22 will use administrator interface 20 to initiate the release to fulfillment step. This permits vendor administrator 22 to specifically define which items in an order are to be filled using electronic marketplace 28 and which are to be filled using the fulfillment centre associated with fulfillment system 26.

Because electronic marketplace 28 is represented in order management system 18 by marketplace fulfillment centre object 30, the system is able to create a release to fulfillment object that references electronic marketplace 28. This is done in the same way that a release to fulfillment object is created to reference fulfillment centre object 24 when items are allocated to inventory at one of the vendor's fulfillment centres. Marketplace fulfillment centre object 30 has a structure that is very close to what is needed for fulfillment centre object 24. Marketplace fulfillment centre object 30 does, however, include a field to indicate that it represents electronic marketplace 28 rather than a fulfillment centre. There is also a field required to track orders placed in electronic marketplace 28.

When vendor administrator 22 determines that certain items should be sourced from electronic marketplace 28, the order management system of the present invention can permit the order item object data for those items to be defined to reference marketplace fulfillment centre object 30 (step 51). The functionality in order management system 18 used to associate items with a vendor fulfillment centre can be used to carry out this step associating the items with electronic marketplace 28. The release to fulfillment step will similarly confirm the assignment of the items to electronic marketplace 28 for sourcing.

In one embodiment, order management system 18 permits vendor administrator 22 to define when electronic marketplace 28 is to be accessed to obtain the items that are to be supplied to customer 10 from the marketplace. This step of placing a marketplace order using the trading mechanism supported by electronic marketplace 28 is analogous to the step of sending fulfillment instructions to fulfillment system 26 when the items are to be supplied from the vendor's own inventory. Order management system 18 includes functionality to ensure that the information required by the particular design of electronic marketplace 18 is able to be provided as part of placing the marketplace order. In one embodiment, this occurs using a shopping cart methodology (step 53) but, as referred to above, other trading mechanisms may be used by electronic marketplace 28.

One anticipated end result of using the trading mechanism supported by electronic marketplace 28 is that items will be drop-shipped from suppliers participating in electronic marketplace 28. This shipment of items is depicted in FIG. 1 by the arrow extending from electronic marketplace 28 to customer 10. It should be noted that suppliers are not required to drop-ship, but could send the items to the vendor, who would repackage them and send them to the customer.

In the system of one embodiment, vendor administrator 22 must be able to track the result of the marketplace order being sent to electronic marketplace 28. The present invention can have a shopping cart reference number defined in the release to fulfillment object. This reference number is accessible to vendor administrator 22 by way of administrator interface 20 and may be used by vendor administrator 22 to manage the purchase transaction in electronic marketplace 28. The system of one embodiment adds the reference number to the release to fulfillment object that is used for the non-marketplace fulfillment centre objects. In other vendor systems, the release to fulfillment object may include a field referencing the corresponding order number in the fulfillment centre. In such a case this field in the release to fulfillment object may be used as the shopping cart reference number when the object is used for orders filled by the marketplace.

In one embodiment, vendor administrator 22 may create a release to fulfillment object for different subsets of items in an order. In this way vendor administrator 22 may determine which items are placed into the same or different shopping carts in electronic marketplace 28. All items in an order destined to the same ship-to address and which are expected to ship at the same time from the same fulfillment centre are typically assigned to the same release. Order management system 18 permits this grouping of items to be overridden. In such a case an item may be configured to be ‘released separately’, for example, if the item is fragile and needs to be wrapped up individually.

Order management system 18 also includes an option that may be specified by vendor administrator 22 when invoking the release to fulfillment command. This option controls whether all items being released will be grouped together in the trading mechanism of electronic marketplace 28 (for example, in a single shopping cart), even if they belong to different release to fulfillment objects, or whether vendor administrator 22 wishes to create one shopping cart per release to fulfillment object. This option is useful in cases where vendor administrator 22 wishes separate items to be separately drop-shipped to customer 10.

The example of FIG. 1 shows items being provided from electronic marketplace 28 directly to customer 10 (as depicted with the arrow from electronic marketplace 28 to customer 10). Alternatively, items may be sent to one of the vendor's fulfillment centres where they may be later sent to customer 10.

Implementations of the invention include implementations as a computer system programmed to execute the process or processes described herein, and as a computer program product.

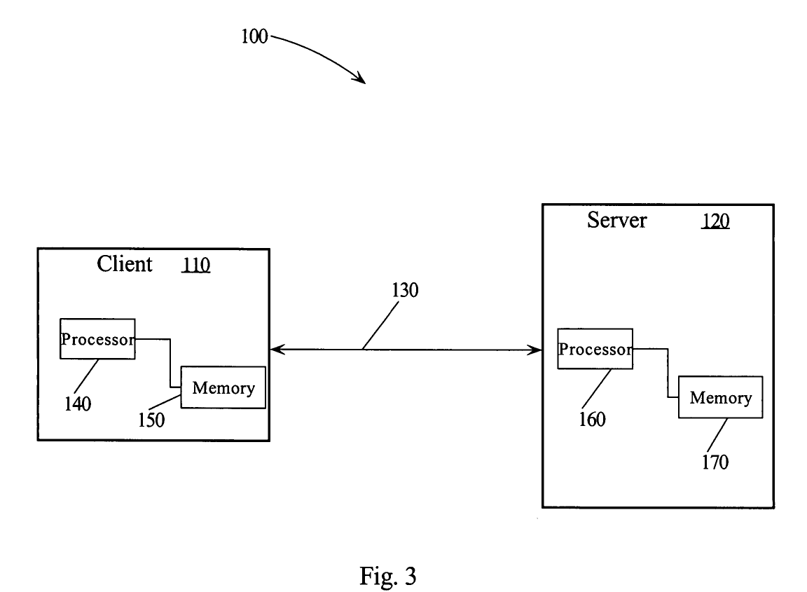

FIG. 3 shows a networked data processing environment 100 where the invention can be used. The data processing environment 100 is an arrangement of one or more client computers 110 and server computers 120 (generally “hosts”) connected to each other by a network 130, for example, the Internet. Users access information and interface with network 130 and server computer 120 through client computer 110.

Client computer 110 can be utilized as part of an e-commerce system on an information network such as the Internet. Client computer 110 includes a processor 140 that executes one or more computer program products stored in memory 150. Similarly, server computer 120 includes a processor 160 that executes one or more computer program products stored in memory 170. Client computer 110 and server computer 120 may be individually programmed to collectively execute the process or processes of the invention described herein.

Those skilled in the art will appreciate that embodiments disclosed herein may be implemented as software program instructions capable of being distributed as one or more program products, in a variety of forms, including computer program products which may be executed by processor 140 of client computer 110 and/or processor 160 of server computer 120, and that the present invention applies equally regardless of the particular type of program storage media or signal bearing media used to actually carry out the distribution. Examples of program storage media and signal bearing media include recordable type media such as floppy disks, CD-ROM, and magnetic tape transmission type media such as digital and analog communications links, as well as other media storage and distribution systems.

Additionally, the foregoing detailed description has set forth various embodiments of the present invention via the use of block diagrams, flowcharts, and/or examples. It will be understood by those skilled within the art that each block diagram component, flowchart step, and operations and/or components illustrated by the use of examples can be implemented, individually and/or collectively, by a wide range of hardware, software, firmware, or any combination thereof. The present invention may be implemented as those skilled in the art will recognize, in whole or in part, in standard Integrated Circuits, Application Specific Integrated Circuits (ASICs), as a computer program running on a general-purpose machine having appropriate hardware, such as one or more computers, as firmware, or as virtually any combination thereof and that designing the circuitry and/or writing the code for the software or firmware would be well within the skill of one of ordinary skill in the art, in view of this disclosure.

While the invention has been described with respect to the embodiments and variations set forth above, these embodiments and variations are illustrative and the invention is not to be considered limited in scope to these embodiments and variations. Accordingly various other embodiments and modifications and improvements not described herein may be within the spirit and scope of the present invention, as defined by the following claims.

1. A computer program product for filling orders for items, the items being supplied from one or more fulfillment centres or from suppliers enrolled in one or more electronic marketplaces, the computer program product comprising a computer usable medium having computer readable program code means embodied in said medium, and comprising:
computer readable program code means for implementing a set of fulfillment centre objects for representing the one or more fulfillment centres and the one or more electronic marketplaces, comprising
a first subset of the fulfillment centre objects being defined for representing corresponding fulfillment centres, and
a second subset of the fulfillment centre objects being defined for representing corresponding electronic marketplaces,
computer readable program code means for implementing a release to fulfillment object for associating one or more items in an order with one of the set of fulfillment centre objects,
computer readable program code means for sending fulfillment instructions relating to one or more items associated with one of the first subset of fulfillment centre objects to the corresponding fulfillment centre, and
computer readable program code means for sending ordering information relating to one or more items associated with one of the second subset of fulfillment centre objects to the corresponding electronic marketplace.

2. The computer program product of claim 1, in which a release to fulfillment object associated with a selected one of the fulfillment centre objects in the second subset comprise data representations for tracking orders in the electronic marketplace corresponding to the selected fulfillment centre object.

3. The computer program product of claim 1, in which each fulfillment centre object comprises data representations for representing inventory and/or fulfillment centre priority.

4. The computer program product of claim 3, in which the data representations for representing inventory and/or fulfillment centre priority in the second subset of fulfillment centre objects represents a null inventory and/or a low fulfillment centre priority.

5. The computer program product of claim 3, further comprising computer readable program code means for pre-selecting items for association with one of the set of fulfillment centre objects based on inventory and/or fulfillment centre priority.

6. The computer program product of claim 5, further comprising computer readable program code means for implementing an administrator interface, the administrator interface comprising means for confirming and over-riding the pre-selection of items for association with one of the set of fulfillment centre objects.

7. The computer program product of claim 1 further comprising computer readable program code means for grouping items and in which the program code means for sending ordering information further comprises program code means for maintaining the grouping of the items when information corresponding to the grouped items is sent to the corresponding electronic marketplace.

8. The computer program product of claim 7 in which the program code means for grouping items comprises program code means for grouping the items corresponding to the order from which the items are received.

9. The computer program product of claim 7 in which the program code means for grouping items comprises program code means for grouping the items corresponding to an aggregation of items from a single order received.

10. An order management system for filling orders for items, the items being supplied from one or more fulfillment centres or from suppliers enrolled in one or more electronic marketplaces, the system comprising:
a set of representation means for representing the one or more fulfillment centres and the one or more electronic marketplaces,
a first subset of the set of representation means for representing corresponding fulfillment centres, and
a second subset of the set of representation means for representing corresponding electronic marketplaces,
means for carrying out a release to fulfillment step for associating one or more items in an order with one of the set of representation means,
means for sending information relating to one or more items associated with one of first subset of representation means to the corresponding fulfillment centre, and for sending information relating to one or more items associated with one of the second subset of representation means to the corresponding electronic marketplace.

11. The order management system of claim 10 in which a release to fulfillment object associated with a selected one of the fulfillment centre objects in the second subset comprise data representations for tracking orders in the electronic marketplace corresponding to the selected fulfillment centre object.

12. The order management system of claim 10 in which each representation means comprises means for representing inventory and/or fulfillment centre priority.

13. The order management system of claim 12 in which each representation means for representing inventory and/or fulfillment centre priority in the second subset of representation means represents a null inventory and/or a low fulfillment centre priority.

14. The order management system of claim 12 further comprising means for pre-selecting items for association with one of the set of representation means based on inventory and/or fulfillment centre priority.

15. The order management system of claim 14 further comprising an administrator interface comprising means for confirming and over-riding the pre-selection of items for association with one of the set of representation means.

16. The order management system of claim 10 further comprising means for grouping items and in which the means for sending information further comprises means for maintaining the grouping of the items when information corresponding to the grouped items is sent to the corresponding electronic marketplace.

17. The order management system of claim 16 in which the means for grouping items comprises means for grouping the items corresponding to the order from which the items were received by the order management system.

18. The order management system of claim 16 in which the means for grouping items comprises means for grouping the items corresponding to an aggregation of items from a single order received by the order management system.

19. A computer-implemented method for filling orders for items using an order management system,
the items being supplied from one or more fulfillment centres or from suppliers enrolled in one or more electronic marketplaces,
the order management system comprising a set of fulfillment centre objects for representing the one or more fulfillment centres and the one or more electronic marketplaces, comprising
a first subset of the fulfillment centre objects being defined for representing corresponding fulfillment centres, and
a second subset of the fulfillment centre objects being defined for representing corresponding electronic marketplaces,
the method comprising the steps of
associating one or more items in an order with one of the set of fulfillment centre objects using a release to fulfillment object,
sending fulfillment instructions relating to one or more items associated with one of the first subset of fulfillment centre objects to the corresponding fulfillment centre, and
sending ordering information relating to one or more items associated with one of the second subset of fulfillment centre objects to the corresponding electronic marketplace.

20. The method of claim 19, in which a release to fulfillment object associated with a selected one of the fulfillment centre objects in the second subset comprise data representations for tracking orders in the electronic marketplace corresponding to the selected fulfillment centre object.

21. The method of claim 19, in which each fulfillment centre objects comprises means for representing inventory and/or fulfillment centre priority.

22. The method of claim 21, in which the means for representing inventory and/or fulfillment centre priority in the second subset of fulfillment centre objects represents a null inventory and/or a low fulfillment centre priority.

23. The method of claim 21, further comprising the step of pre-selecting items for association with one of the set of fulfillment centre objects based on inventory and/or fulfillment centre priority.

24. The method of claim 19, in which the order management system comprises an administrator interface, and the method further comprises the step of an administrator using the administrator interface to confirm or over-ride the pre-selection of items for association with one of the set of fulfillment centre objects.

25. The method of claim 19, further comprising the step of grouping items and in which the step of sending ordering information further comprises maintaining the grouping of the items when information corresponding to the grouped items is sent to the corresponding electronic marketplace.

26. The method of claim 25 in which the step of grouping items comprises grouping the items corresponding to the order from which the items were received by the order management system.

27. The order management system of claim 25 in which the step of grouping items comprises grouping the items corresponding to an aggregation of items from a single order received by the order management system.

28. In a computer program product for filling orders for items, the computer program product comprising a computer usable medium having computer readable program code means embodied in said medium for implementing a set of fulfillment centre objects for representing one or more fulfillment centres, for implementing a release to fulfillment object for associating one or more items in an order with one of the set of fulfillment centre objects and for sending fulfillment instructions relating to one or more items associated with one of the first subset of fulfillment centre objects to the corresponding fulfillment centre,
further computer readable program code means embodied in said medium for representing one or more electronic marketplaces as fulfillment centre objects whereby fulfillment instructions relating to items associated with the said fulfillment centre objects representing electronic marketplaces are directed to the represented electronic marketplaces.
